(19) United States
(12) Patent Application Publication
(10) Pub. No.: US 2024/0117834 A1
(43) Pub. Date: Apr. 11, 2024

(54) TOOL AND FASTENER WITH OVERHANG STRUCTURES TO REDUCE STRIPPING

(71) Applicant: Phillips Screw Company, Amesbury, MA (US)

(72) Inventors: Christopher M. Gallant, Nottingham, NH (US); Gary E. Dilling, Ashburnham, MA (US)

(73) Assignee: Phillips Screw Company, Amesbury, MA (US)

(21) Appl. No.: 18/473,762

(22) Filed: Sep. 25, 2023

Related U.S. Application Data
(60) Provisional application No. 63/413,382, filed on Oct. 5, 2022.

(51) Int. Cl. F16B 23/00; B21K 1/46; B23G 9/00; B25B 15/00; B25B 23/10

(52) U.S. Cl. CPC F16B 23/0023; B21K 1/463; B23G 9/002; B25B 15/005; B25B 23/108

(57) ABSTRACT

A fastener designed to reduce or eliminate stripping the fastener (e.g., as a result of camming-out during drilling of the fastener either into or out of a material). Also, a driver bit tip design to engage with the fastener, along with a tool designed to form the fastener, as well as a method of forming the fastener. In an example, the fastener includes a shank and a head on one end of the shank. The head comprises a recess pattern that includes one or more wing recesses with sidewalls that extend from the head towards the shank. The head further includes an overhang structure at a top end of the at least one of the sidewalls, the overhang structure extending laterally outward from the sidewall. A corresponding driver bit includes a complementary feature that engages with the overhang structure to inhibit cam-out.

### CROSS-REFERENCE TO RELATED APPLICATION

This application claims the benefit of U.S. Provisional Application No. 63/413,382 filed Oct. 5, 2022, which is incorporated herein by reference in its entirety.

### FIELD OF THE DISCLOSURE

This disclosure relates to fastener systems, and more particularly, to a tool for forming a new fastener design that reduces or eliminates stripping of the fastener.

### BACKGROUND

Fasteners such as screws and bolts often have a head recess pattern within which a driver bit fits and turns in order to drive the fastener into (or out of) a workpiece. If the fastener is experiencing non-trivial resistance during the driving process, the bit may jump out of the fastener's recess (sometimes referred to as cam-out) and eventually strip away some of the fastener material on the head of the fastener or otherwise deform the recess pattern. Such cam-out may be related to factors such as the length of the fastener, the gauge of the fastener, and the hardness or bore-resistance of the material into which the fastener is being driven. In any such cases, if the recess pattern becomes too damaged, the driver bit may no longer be able to drivingly-engage the fastener. In such cases, the fastener is said to be stripped. Stripped fasteners are difficult to remove or otherwise work with and continue to be a problem.

### BRIEF DESCRIPTION OF THE DRAWINGS

FIGS. 1A-1D illustrate different perspective and cross-sectional views of a punch tool for forming the head recess pattern of a strip-resistant fastener, in accordance with some embodiments of the present disclosure.

FIGS. 2A-2C illustrate different perspective and cross-sectional views of an example strip-resistant fastener with ramp structures that can be used to form overhang structures as shown in FIGS. 3A-3C, in accordance with some embodiments of the present disclosure.

FIGS. 3A-3C illustrate different perspective and cross-sectional views of the example strip-resistant fastener of FIGS. 2A-2C after the ramp structures have been converted to overhang structures, in accordance with some embodiments of the present disclosure.

FIGS. 4A-4C illustrate perspective and cross-section views of an example driver bit tip configured to securely engage within the recess pattern of the strip-resistant fastener head of FIGS. 3A-3C, in accordance with some embodiments of the present disclosure.

FIG. 5 illustrates the engagement that occurs between the strip-resistant fastener head of FIGS. 3A-3C and the driver bit tip of FIGS. 4A-4C, in accordance with some embodiments of the present disclosure.

FIGS. 6A-6C illustrate different perspective and cross-sectional views of a punch tool for forming the head recess pattern of another strip-resistant fastener, in accordance with some embodiments of the present disclosure.

FIGS. 7A-7C illustrate different perspective and cross-sectional views of an example strip-resistant fastener with dual ramp structures that can be used to form dual overhang structures as shown in FIGS. 8A-8C, in accordance with some embodiments of the present disclosure.

FIGS. 8A-8C illustrate different perspective and cross-sectional views of the example strip-resistant fastener of FIGS. 7A-7C after the dual ramp structures have been converted to dual overhang structures, in accordance with some embodiments of the present disclosure.

FIGS. 9A-9C illustrate perspective and cross-section views of an example driver bit tip configured to securely engage within the recess pattern of the strip-resistant fastener head of FIGS. 8A-8C, in accordance with some embodiments of the present disclosure.

FIG. 10 illustrates the engagement that occurs between the strip-resistant fastener head of FIGS. 8A-8C and the driver bit tip of FIGS. 9A-9C, in accordance with some embodiments of the present disclosure.

FIGS. 11A-11F collectively illustrate a manufacturing process for forming a strip-resistant fastener, in accordance with some embodiments of the present disclosure.

### DETAILED DESCRIPTION

Techniques to reduce or eliminate stripping of fasteners are described herein. The fasteners are configured to reduce or eliminate cam-out during driving of the fastener, either into or out of a material, which in turn reduces or eliminates stripping of the fastener. A driver bit tip design configured to lockingly engage with the fastener is also described herein, along with a punch tool designed to form the strip-resistant fastener, as well as a method of forming the strip-resistant fastener. The locking engagement between the fastener and driver bit provides a “cammed-in” interface. As further described below, such a “cammed-in” interface allows a low to zero operator drive force to be used during a given drive operation, or even a negative operator drive force given that the fastener can pull the cammed-in driver bit in the drive direction. Relative to other strip-resistant designs, the techniques provided herein facilitate a highly manufacturable fastener that includes a multi-blow punch and stamp process, without the need for high-precision and costly manufacturing techniques such as computerized numerical control (CNC) machining.

In an embodiment, a strip-resistant fastener includes a shank and a head at one end of the shank. The head comprises a recess pattern that includes one or more wing recesses with sidewalls that extend from the head towards the shank. The head also includes an overhang structure at a top end of at least one of the sidewalls. The overhang structure extends laterally outward from the sidewall. In some such examples, the sidewall may be relatively straight such that it is substantially parallel (e.g., within 5 degrees or less) to a central axis running through the shank and head, while in other examples the sidewall may consistently taper inward as it extends towards the shank such that the bottom of the recess is narrower than the top of the recess. Note that rounding at the bottom of the recess may interrupt the consistent inward taper. In any such cases, the overhang structure effectively interrupts the otherwise relatively consistent trajectory of the sidewall by abruptly protruding laterally outward from the sidewall at the top of the recess, and facilitates cam-in functionality in one of the two drive directions. In some other examples, any of the one or more wing recesses includes an overhang structure on each of its two opposing sidewalls. The two overhang structures of a given wing recess may protrude laterally towards the center of the given wing recess, and facilitate cam-in functionality in both drive directions (one overhang structure engages with driver bit while driving the fastener into the given workpiece, and the other overhang structure engages with driver bit while removing (backing out) the fastener from the given workpiece.

According to another embodiment, a driver bit includes a shank and a tip at one end of the shank. The tip comprises one or more wings extending away from the shank. At least one of the one or more wings includes a first section having a first width and a second section having a second width greater than the first width. The first section is between the shank and the second section. Such a driver bit can be used to drive a strip-resistant fastener, as variously described herein. For example, the driver bit includes a step at the transition from the first section to the second section, and that step can lockingly engage with the outwardly extending protrusion(s) or overhang structure(s) of the fastener head described above. The driver bit can be used, for example, in a rotary tool or screwdriver application (e.g., such as where the rotary tool or screwdriver includes a chuck into which the driver bit can be securely retained during a drive operation).

According to another embodiment, a punch tool designed to form the head shape of a strip-resistant fastener includes a body having a punch point at an end of the body. The punch point includes one or more wings extending away from the surface and arranged in a pattern that matches a recess pattern on a head of the strip-resistant fastener. The punch point further includes at least one pocket extending below the surface and directly adjacent to a corresponding wing of the one or more wings. In operation, the punch point is pushed into a blank of the fastener material (e.g., in a cold-forming machine) to form the recess pattern in a head of the fastener. Additionally, the fastener material is pushed into the at least one pocket to form one or more ramp structures that each extend outward from the head of the fastener. A given such ramp structure subsequently can be pushed down into the recess to form a corresponding overhang structure that laterally protrudes into the recess pattern of the fastener head, and that engages with a step feature of a driver bit tip to reduce or eliminate cam-out.

According to another embodiment, a method of forming a fastener includes aligning a material blank over a die shaped to form a part of the fastener; punching the material blank into the die using a first blow assembly; punching the material blank with a second blow assembly to form a recess pattern in a head of the fastener and one or more ramp structures arranged around the recess pattern; punching the head of the fastener with a third blow assembly having a flat front surface, thereby bending or mashing the ramp structures into the top portion of the recess pattern. In some such embodiments, note that the fastener being formed can be held in one position, and the various punching operations are switched in and out of position. In other embodiments, the punching operations are fixed in position and the fastener being formed is moved from one punching operation to the next. Still other embodiments may include a combination where some forming operations are fixed in location and the fastener is moved to those locations, and some forming operations are moved to a fixed fastener location. More generally, the forming operations described herein can be used to provide strip-resistant fasteners, whether by shifting blow assemblies in and out of position (e.g., shifting the second blow assembly away and shifting the third blow assembly in place over the head of the fastener, and so on) with respect to a fixed workpiece fastener, or vice-versa (e.g., shifting the fastener being formed away from the second blow assembly to the third blow assembly, and so so), or any combination of such shifting actions.

Numerous embodiments will be appreciated in light of this disclosure.

General Overview

As previously explained, there are a number of non-trivial issues with respect to using fasteners. For instance, if a fastener head strips due to camming-out of the driver bit, the fastener can be very difficult to properly seat into, or remove from, a material. Machining particular recess shapes in the fastener head that could prevent cam-out is one possible solution, but such solutions are not practical for high volume manufacturing of fasteners.

Thus, strip-resistant fasteners and forming techniques are described herein. In an example, a punch tool that can be used within a standard cold-forming machine is described that can form a fastener with a head design that includes ramp structures which can be readily converted to overhang structures configured to eliminate or otherwise reduce the occurrence of cam-out and stripping. The punch tool includes a punch bit (or punch point) with a unique design that forms one or more wing recesses in a fastener head (such as a cross-pattern or tri-cross pattern) and also forms ramp structures on at least one edge of one or more of the wing recesses. These ramp structures can be pressed down into the top portion of the recesses to form overhang structures that jut out from at least one sidewall of one or more of the wing recesses. The overhang structures can then engage with a corresponding sidewall step structure that extends out from one or more of the wings at the end of a driver bit, thus locking the bit in place while it twists the head of the fastener and preventing the bit from camming-out. In this sense, the bit can effectively “cam-in” during the driving or loosening process, or otherwise reduce cam-out. Various locking features can be provided on one or both of the driver tip and the recess pattern on the fastener head to “cam-in” the bit during the driving or loosening process. For example, an overhang structure of the fastener may engage with a corresponding sidewall step of the bit to lock in the bit during a driving operation while rib structures on the bit may engage with a corresponding rib structure on the fastener to help prevent cam-out of the bit during a loosening operation.

The accompanying figures further demonstrate some example embodiments. The example dimensions depicted are not intended to be limiting on the present disclosure; rather, any number of similar shapes of particular components or dimensions will be appreciated in light of this disclosure.

Punch Tools, Fasteners, and Drive Bits

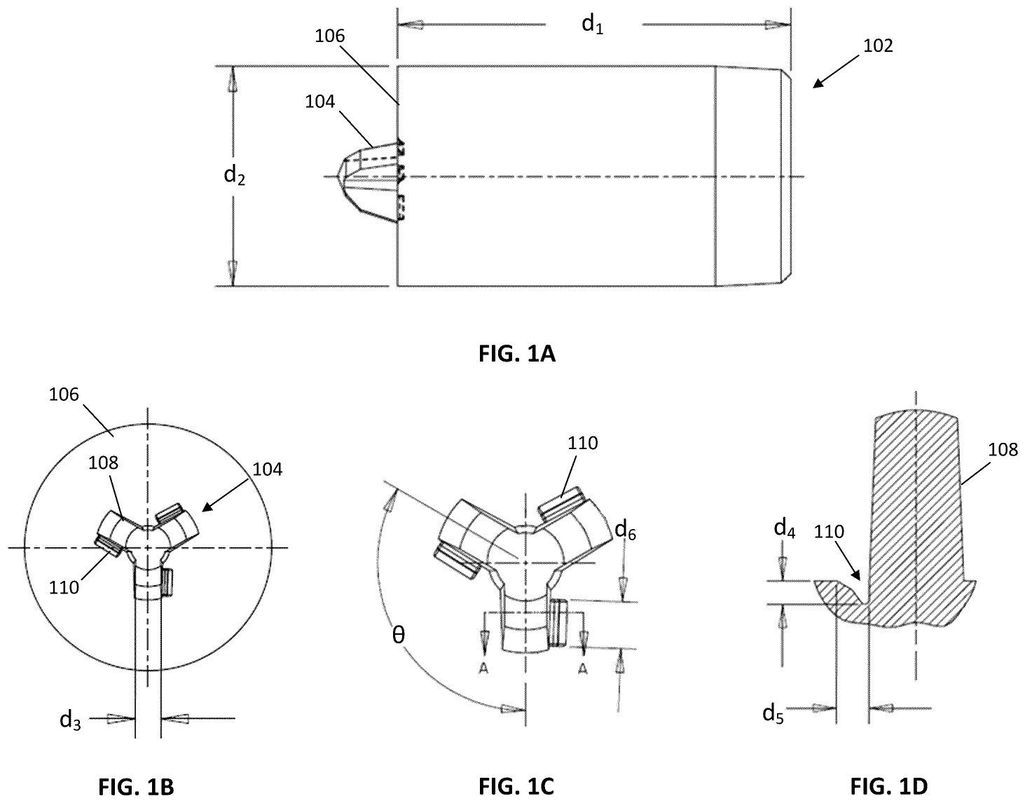

FIGS. 1A-1D illustrate several cross-sectional and perspective views of a punch tool and of the punch point at the end of the punch tool, according to some embodiments. FIG. 1A illustrates a view of a punch tool 102 while FIGS. 1B-1D illustrate various views of a punch point 104 at one end of punch tool 102. FIG. 1D is a cross section view taken across plane A-A shown in FIG. 1C. When used in a cold-forming machine (or similar system), punch tool 102 may be driven towards a material blank such that punch point 104 forms a fastener head in the material blank. Punch point 104 extends away from an end face 106 of punch tool 102. In some embodiments, punch tool 102 may have a length d₁ between about 0.90″ and about 1.00″ or between about 0.960″ and about 0.968″ and may have a width d₂ between about 0.50″ and about 0.60″ or between about 0.550″ and about 0.552″. Other examples of punch tool 102 may have different dimensions.

According to some embodiments, punch point 104 includes a particular shape that is used to form at least part of the recess pattern in the fastener head as will be shown in more detail in later figures. In the illustrated example, punch point 104 includes three wings 108 arranged in a tri-cross pattern (with a same angle θ of about 120 degrees between each adjacent set of wings). Any number of wings may be used with any angle between adjacent wings. Another example is a cruciform pattern with four wings (about 90 degrees between each adjacent set of wings). Another such example is a flat pattern using an elongated slot, which includes two wings aligned co-planar to one another (e.g., with 180 degrees between them). More generally, any fastener head pattern configured to allow for twisting engagement of the given fastener by a drive bit can be used, wherein each of the punch point, fastener, and drive bit can be configured as variously described herein to provide a strip-resistant fastener system. Example other patterns include star, hex, square, or any other recess pattern or shape into which an overhang feature as described herein can be formed.

According to some embodiments, each of wings 108 extends toward the tip end of the punch tool and meets at a central point. Each of the wings 108 may be considered to have a length that extends radially outward from an axis passing axially through the central point of punch point 104. According to some such embodiments, at least one of the wings 108 includes a pocket 110 directly adjacent to the wing 108 as variously shown in the cross-section and perspective views of punch point 104 in FIGS. 1B-1D. As shown in the cross-section view of FIG. 1D, pocket 110 may have a greatest depth directly adjacent to its corresponding wing 108 (e.g., along a sidewall of the wing). The depth of pocket 110 may decrease moving away from the wing to create a sloped or stepped profile. The greatest depth d₄ of the pocket 110 may be, for example, between about 0.014″ and about 0.022″. In some such embodiments, pocket 110 may extend laterally away from its adjacent wing 108 by a distance d₅ between about 0.015″ and about 0.030″, such as about 0.022″. As seen in FIGS. 1B and 1C, a given pocket 110 can extend lengthwise along nearly an entire length of the corresponding adjacent wing 108. In some such embodiments, a given pocket 110 extends lengthwise along at least 30%, at least 50%, or at least 75% of the total length of the corresponding wing 108. In some specific such example embodiments, a given pocket 110 extends lengthwise by a distance d₆ between about 0.050″ and about 0.070″, such as around 0.061″. In some embodiments, each of the wings 108 of the punch point 104 has a corresponding pocket 110 adjacent to it.

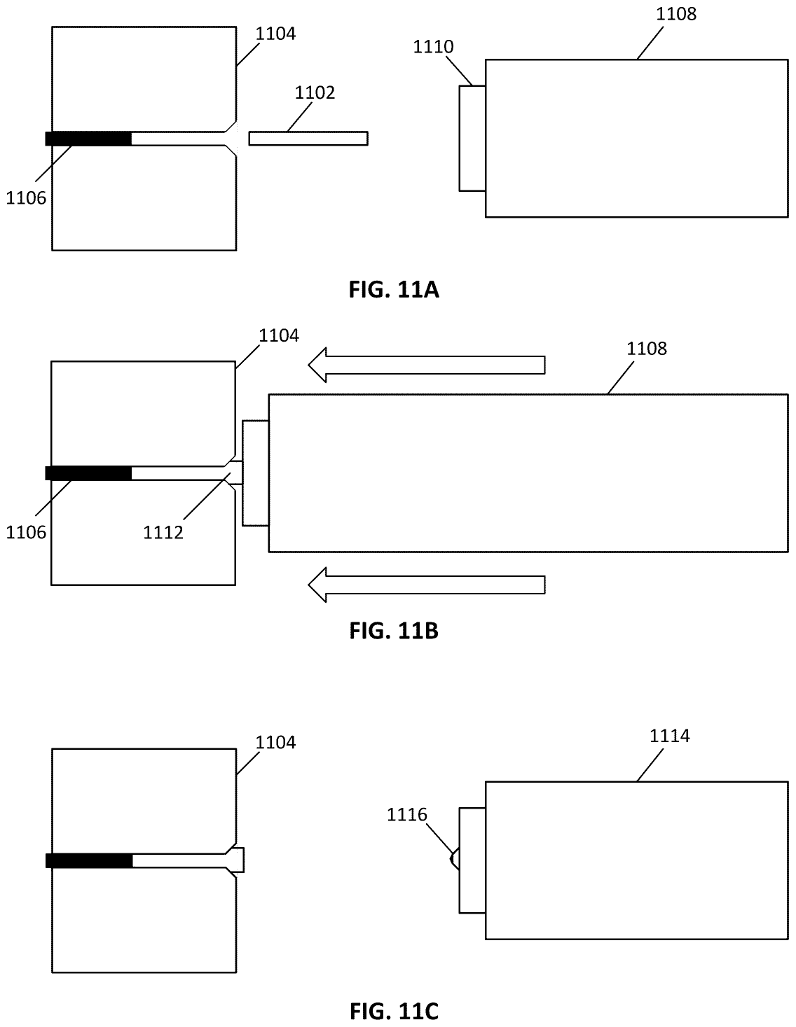

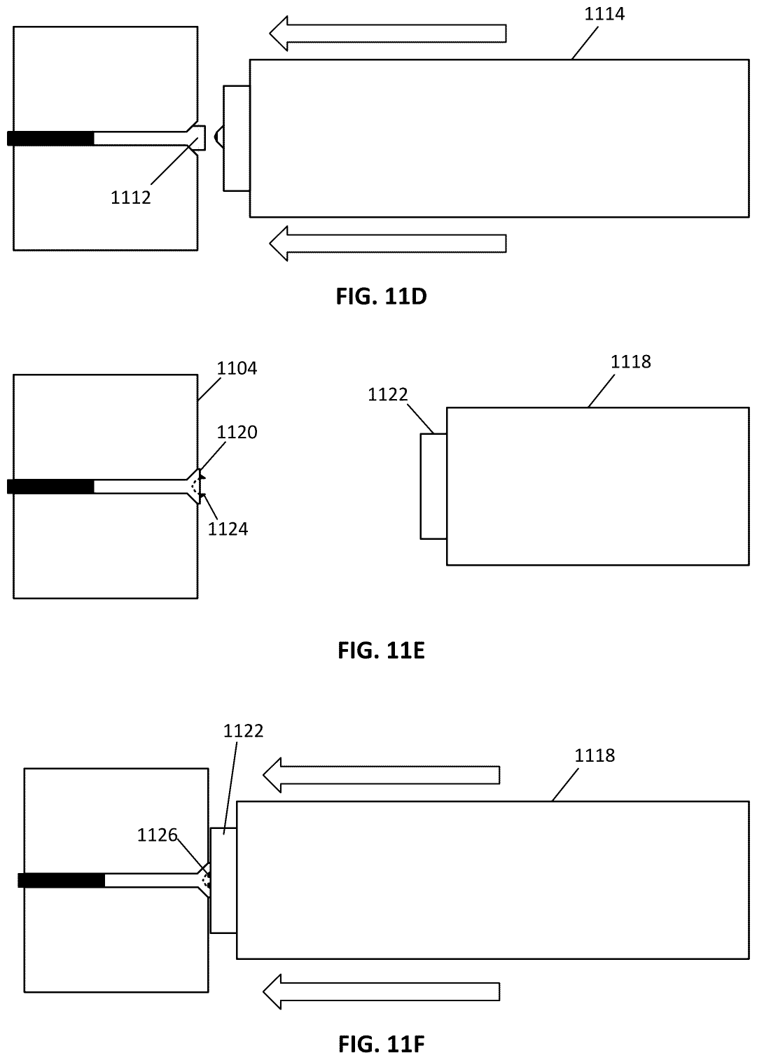

Note that another punch tool or other forming tool may be used to form the general flattened head shape and/or a standard recess pattern therein prior to using the depicted punch tool. In such cases, punch tool 102 can then be used to form at least one or more ramp structures within the one or more pockets 110 and adjacent to the one or more of the wings 108. Further example details regarding the formation of a fastener using punch tool 102 within a cold-forming machine-based process are provided with reference to FIGS. 11A-11F.

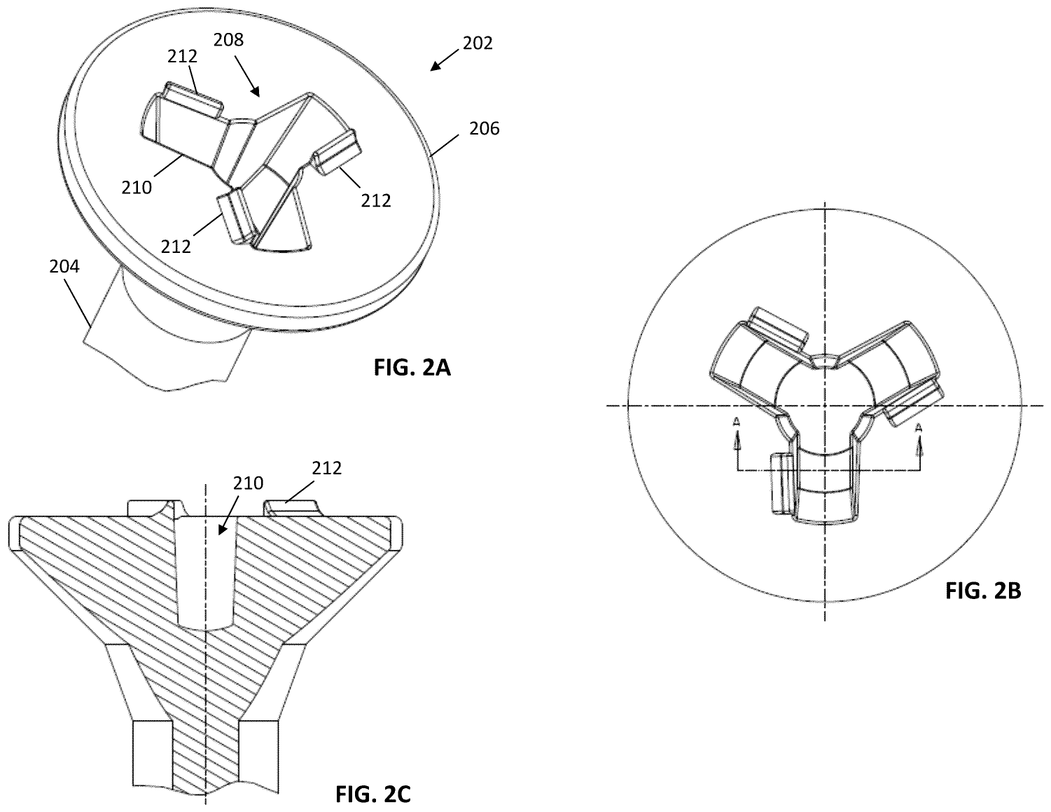

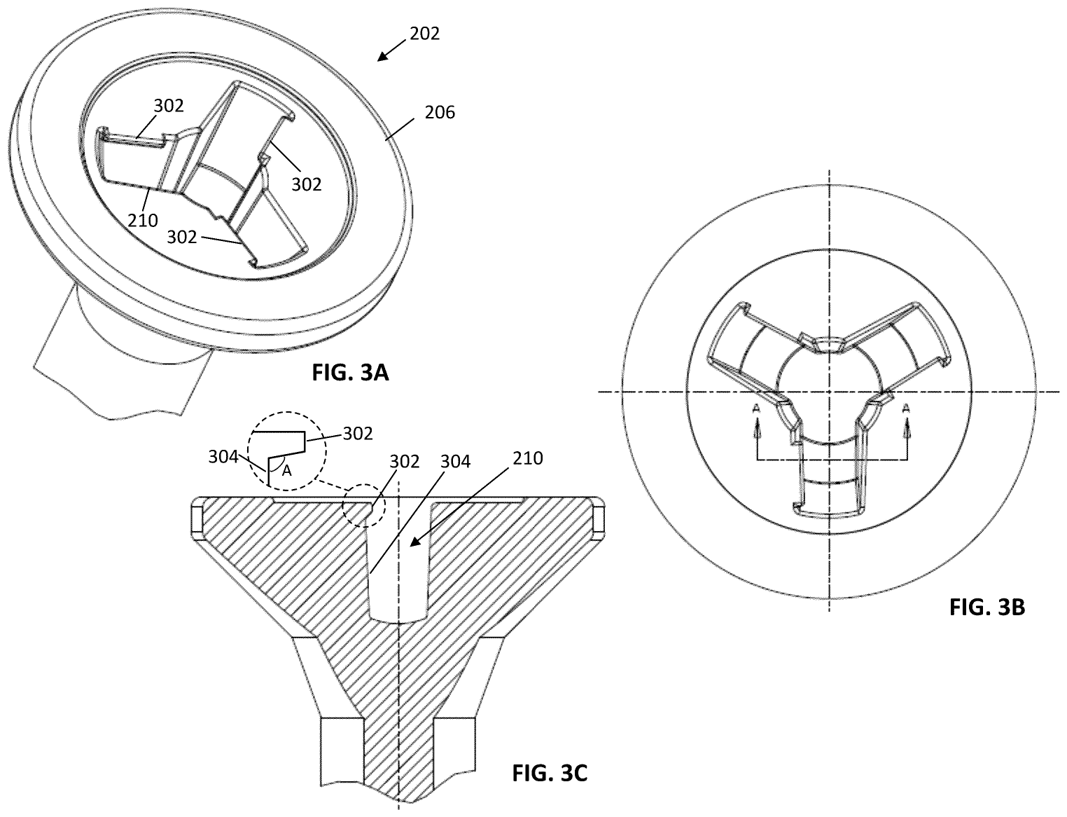

FIGS. 2A-2C illustrate several cross-sectional and perspective views of an example fastener after a first stage of its formation, according to some embodiments. FIG. 2C provides a cross-section view taken across the plane A-A from FIG. 2B. Fastener 202 results from using punch tool 102 to form the recess pattern in the head of the fastener as well as ramps extending upward from the fastener head surface. Note that fastener 202 is not yet fully completed, as the ramps have not yet been pressed downward into the recess to form the overhang structures as shown in FIGS. 3A-3C.

As can be seen, fastener 202 includes a shank 204 (an elongated body with the majority not being shown) with a tip at one end (not shown) and a head 206 at the opposite end. Shank 204 may include one or more threads along at least a portion of a length (extending between the head and the tip) of the shank (e.g., as would be seen on a screw or bolt). Head 206 includes a recess pattern 208 formed from one or more wing recesses 210. In the illustrated example, three wing recesses 210 form a tri-cross pattern in head 206 of fastener 202; other examples may include other patterns, as described above. The wing recess pattern 208 matches the wing pattern of punch point 104 on the corresponding punch tool 102 used to form head 206 of fastener 202. As can be further seen, each wing recess 210 includes a ramp structure 212 directly adjacent to wing recess 208. Ramp structures 212 may be formed on the fastener head 206 due to material being pushed into the one or more pockets 110 of punch point 104 during the formation of the fastener head. Accordingly, ramp structure 212 is molded to match the geometry of pocket 110 in punch point 104. In some examples, a sidewall of the wing recess 210 is aligned with (e.g., is co-planar with) an inward-facing sidewall of the corresponding ramp structure 212 such that there is a seamless transition between the two sidewalls (e.g., the fastener shank, head, and ramp structures are all one monolithic and continuous piece of metal or other fastener material of a given blank). In the example shown, each wing recess 210 has a corresponding ramp structure 212 adjacent to it; other embodiments may be configured differently, such as the example case where only one of recesses 210 has a corresponding ramp structure 212, or the example case where some but not all of recesses 210 each has a corresponding ramp structure 212. Given the nature of the forming process, the ramp structures 212 and the fastener head 206 can be a continuous body of material. In this manner, each ramp structure 212 may be said to be monolithically integrated with the fastener head 206.

FIGS. 3A-3C illustrate several cross-sectional and perspective views of the example fastener of FIGS. 2A-2C after a next (e.g., second) stage of its formation, according to some embodiments. FIG. 3C provides a cross-section view taken across the plane A-A from FIG. 3B. The fastener 202 shown in FIGS. 3A-3C results from using another punch tool to flatten down ramp structures 212 and form corresponding overhang structures 302. As can be seen, overhang structures 302 are in generally the same locations as ramp structures 212 along the sides of their corresponding wing recesses 210. According to some embodiments, a given overhang structure 302 extends laterally outwards from a sidewall 304 of its adjacent wing recess 210. Overhang structure 302 extends outward at a top of wing recess sidewall 304. In some examples, a top surface of overhang structure 302 may be aligned with (e.g., co-planar with) a top surface of the head 206 of the fastener. In some examples, the top surface of the fastener head 206 may be indented with a raised outer ring around the top surface. Each of overhang structures 302 may extend, for example, lengthwise along at least 30% or at least 50% or at least 75% of the total length of the corresponding wing recess 210 adjacent to it. In some such examples, a given overhang structure 302 extends lengthwise by between about 0.050″ and about 0.070″, such as around 0.061″. A given overhang structure 302 may laterally extend outward from sidewall 304 by, for example, between about 0.015″ and about 0.030″, according to some examples. In the example shown, each of the wing recesses 210 of fastener 202 has a corresponding overhang structure 302 adjacent to it; other embodiments may be configured differently, such as the example case where only one of recesses 210 has a corresponding overhang structure 302, or the example case where some but not all of recesses 210 each has a corresponding overhang structure 302. Given the nature of the forming process, the overhang structures 302 and the fastener head 206 can be a continuous body of material. In this manner, each of the overhang structures 302 may be said to be monolithically integrated with the fastener head 206.

Note that overhang structure(s) 302 may not look as pristine as they do in the figures, given the real-world process limitations attributable to a punch-based forming process. For instance, instead of having crisp or otherwise sharp corners as depicted, overhang structure(s) 302 formed as described herein may have rounded corners, and/or non-straight edges. To this end, overhang structure(s) 302 need not have a highly machined look and feel, as will be appreciated. In some examples, the recess sidewalls 304 may be relatively straight such that they are substantially parallel (e.g., within 5 degrees or less) to a central axis running through shank 204 and head 206. In other examples, wing recess sidewalls 304 may consistently taper inward as they extend towards shank 204, such that the bottom of a given wing recess 210 is narrower than the top of that recess. Note that rounding at the bottom of the wing recess 210 may interrupt the consistent inward taper. In any such cases, overhang structure 302 projects abruptly inward at the top of wing recess 210 and effectively interrupts the otherwise relatively consistent trajectory of the corresponding wing recess sidewall 304. This is in contrast, for example, to a wing recess sidewall that consistently tapers outward (reverse-taper) as it extends towards the shank such that the bottom of the wing recess is wider than the top of the wing recess. Such a reverse-taper design may help in resisting stripping but lacks the outwardly extending overhang structure 302 and would be more difficult to manufacture in a high-volume process (e.g., such a design is not conducive to a blow-based manufacturing process). Further note that, given the protruding nature of the overhang structures 302, a bottom surface of a given overhang structure 302 is not co-planar with a corresponding sidewall. To this end, an angle A is formed by the bottom surface of the overhang structure 302 and the corresponding sidewall 304. In the example shown in FIG. 3A, angle A is an oblique angle. However, in other examples, angle A may be a right angle or an acute angle. As described above, the bottom surface of overhang structures 302 may be rounded or curvilinear or otherwise non-straight.

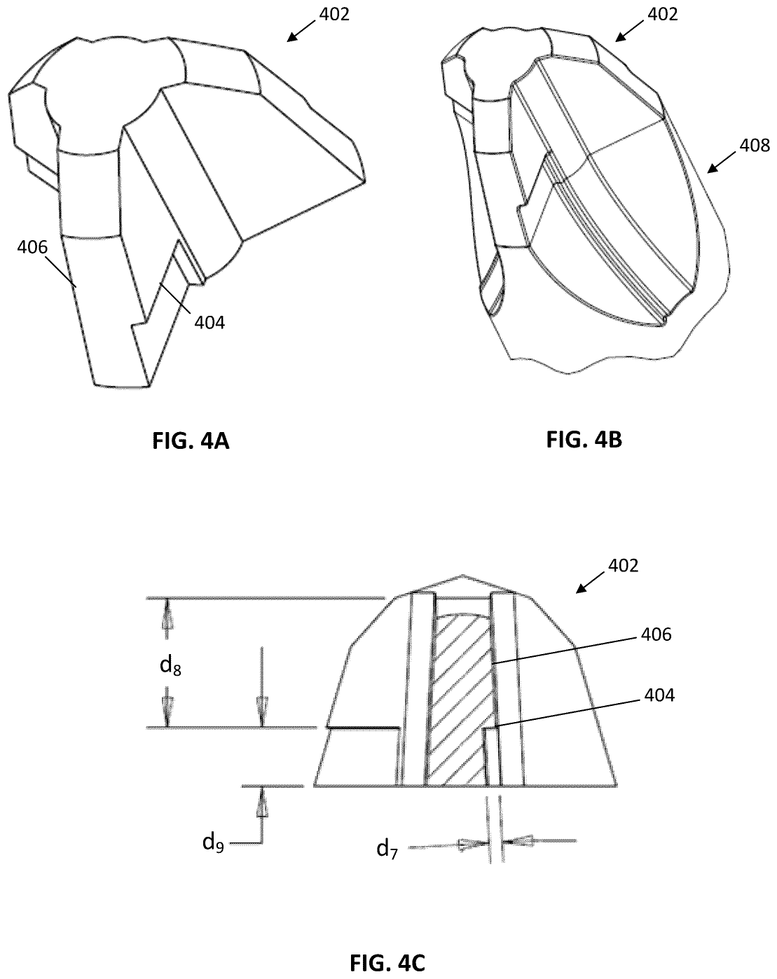

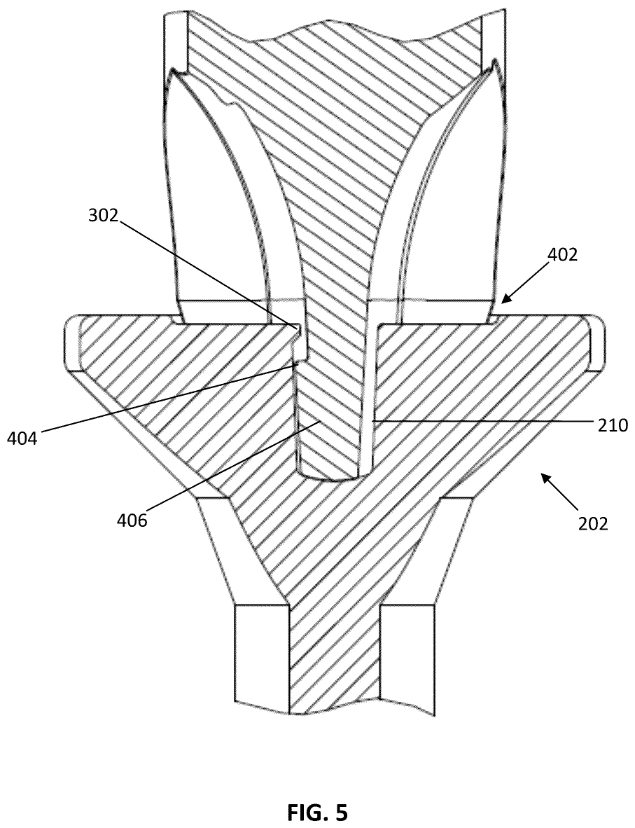

FIG. 4A illustrates a perspective view of a driver bit tip 402 for engagement with the strip-resistant fastener 202 of FIG. 3A, according to some embodiments. FIG. 4B illustrates a perspective view of driver bit tip 402 at the end of a shank 408, which may include an elongated body that continues to extend away from driver bit tip 402 to a distal end configured to engage with a driver tool (e.g., rotary tool, screwdriver, etc.). FIG. 4C illustrates a side view of driver bit tip 402.

Driver bit tip 402 includes step features 404 that are designed to engage with the overhang structure(s) 302 of fastener 202 to “lock” the bit in place and reduce or eliminate cam-out when driving fastener 202 into a workpiece. According to some embodiments, driver bit tip 402 includes one or more wings 406 that have a similar design to punch point 104 used to form the fastener design. Accordingly, driver bit tip 402 includes one or more wings 406 arranged in a given pattern that matches the wing recess pattern 208 found on fastener head 206. In the illustrated example, driver bit tip 402 includes three wings in a tri-cross pattern. Other patterns may be used, as described above.

According to some embodiments, at least one of the wings 406 includes a stepped design with two sections having different widths. A first section of wing 406 may have a first width and a second section of the wing may have a second width that is greater than the first width. The difference in widths between the sections creates a step discontinuity along a sidewall of wing 406 at the boundary between the two sections. The first sidewall section may be located between the second sidewall section and shank 408.

As seen in FIG. 4C, the difference in width between the first sidewall section and second sidewall section may have a value d₇ between about 0.08″ and about 0.12″, according to some examples. In some embodiments, a total height of the second sidewall section is at least 1.5× or at least 2.0× a total height of the first sidewall section. In some examples, a total height of the second sidewall section d₈ is between about 0.095″ and about 0.105″ and the total height of the first sidewall section d₉ is between about 0.040″ and about 0.050″.

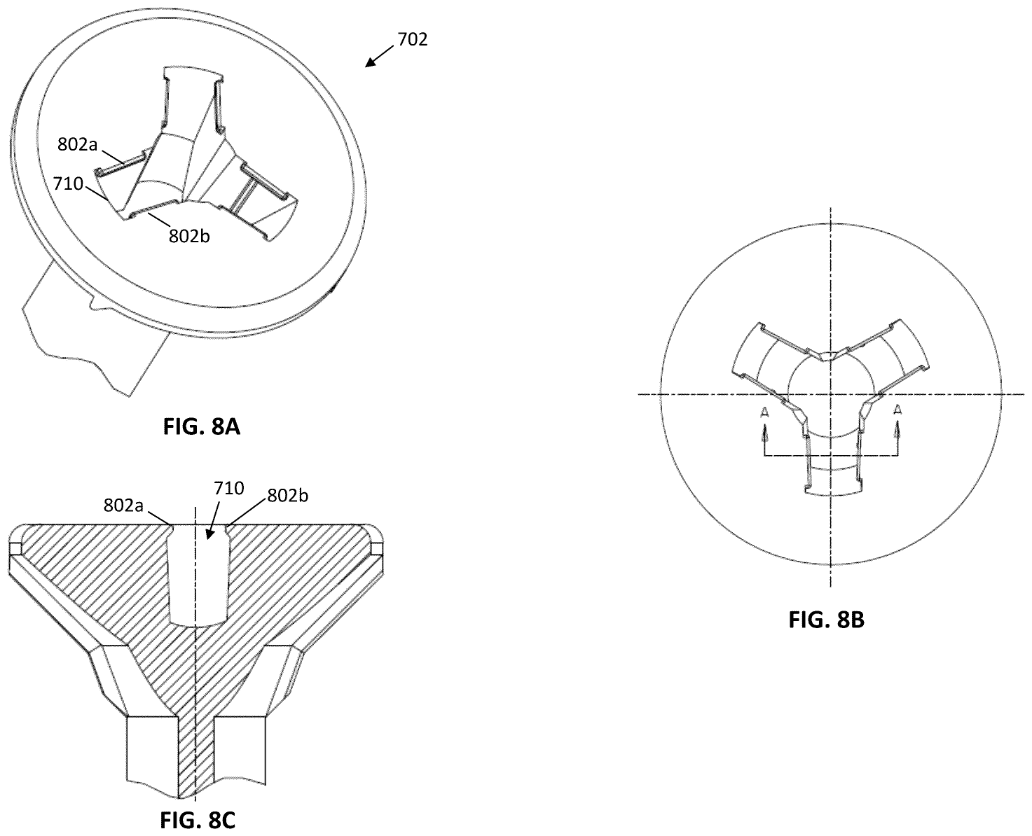

FIG. 5 illustrates a driver bit tip 402 having been inserted into a strip-resistant fastener 202, according to some embodiments. Once the driver bit tip wings 406 have been inserted into the corresponding wing recesses 210 of the fastener head, driver bit tip 402 is twisted to engage step 404 (from the wing of the driver bit tip having two sidewall sections) below a corresponding overhang structure 302. At this point, driver bit tip 402 is “cammed-in” or otherwise locked in place and will not cam-out when tightening the fastener. As noted above, driver bit tip 402 may be on the end of a shank that extends away from driver bit tip 402 for easier coupling to, for example, a rotary tool or a screwdriver. Note that the same interlocking overhang and step features can be formed in the opposite recess pattern sidewalls, to facilitate cam-in during a loosening operation (such as shown in the examples of FIGS. 8A-C and 10).

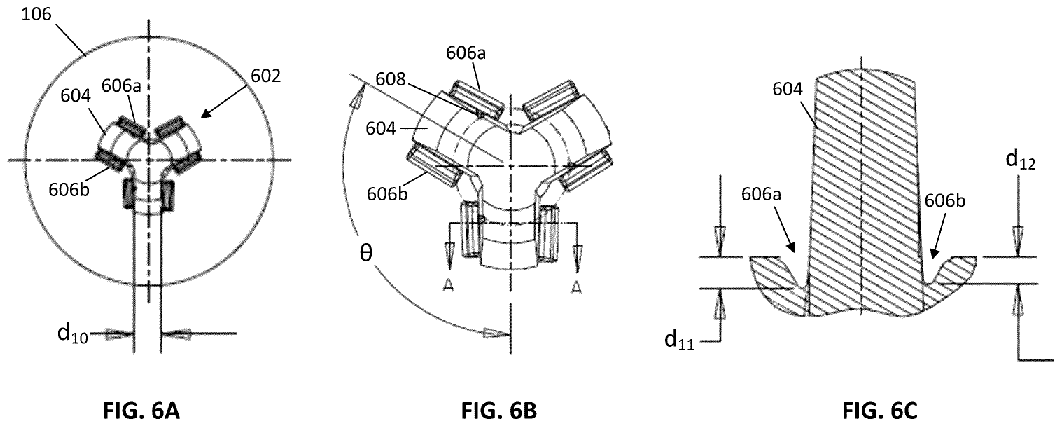

FIGS. 6A-6C illustrate several cross-sectional and perspective views of another punch point 602 on end face 106 of punch tool 102, according to some embodiments. FIG. 6C is a cross section view taken across plane A-A shown in FIG. 6B. Punch point 602 may include any number of wings 604 as described above for punch point 104. However, punch point 602 includes pockets 606a and 606b on either side of one or more of wings 604. Each of pockets 606a and 606b may have substantially the same geometry and purpose as pocket 110 described above. Accordingly, punch point 602 may be used to form fastener heads with overhang structures on both sidewalls of one or more of the wing recesses to facilitate cam-in of a bit during both tightening and loosening operations.

In some examples, each wing 604 of punch point 602 may have a width d₁₀ between about 0.050″ and about 0.070″. According to some embodiments, pockets 606a and 606b on either side of a given wing 604 may not have the same geometry. This can be done to create a larger overhang on the wall that engages with the driver bit during a tightening operation vs the opposite wall that engages with the driver bit during a loosening operation. For example, a depth d₁₁ of first pocket 606a may be between 0.014″ and about 0.018″ while a depth d₁₂ of second pocket 606b may be between about 0.011″ and about 0.015″. Various geometries may be considered for each of first pocket 606a and second pocket 606b.

According to some embodiments, one or more of wings 604 includes a notch 608 along one of its sidewalls. Notch 608 may extend vertically along an entire height, or at least along 50% of an entire height, of each wing 604. Notch 608 may have the shape of a concave recess when viewed from the side of punch point 602. Notch 608 may have any suitable indented geometry. According to some embodiments, notch 608 is present along a sidewall of wing 604 that forms a corresponding wing recess sidewall in a fastener that engages with a bit during a loosening operation, as will be discussed in more detail herein.

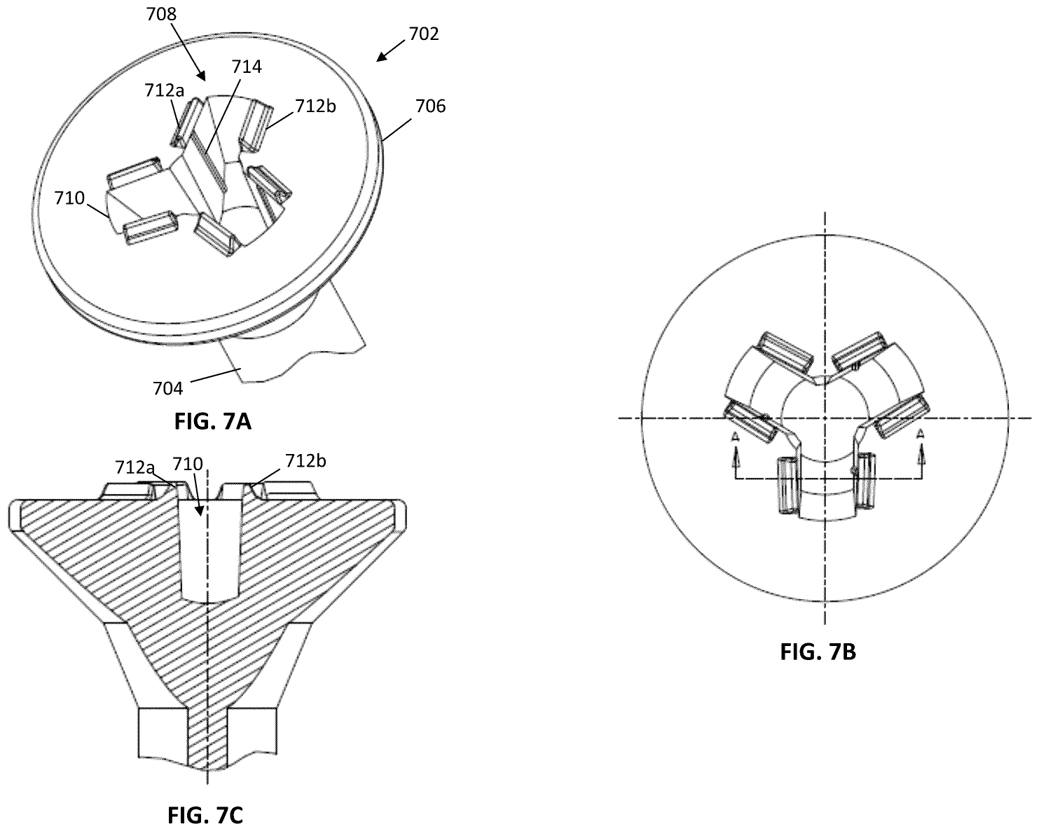

FIGS. 7A-7C illustrate several cross-sectional and perspective views of an example fastener after a first stage of its formation, according to some embodiments. FIG. 7C provides a cross-section view taken across the plane A-A from FIG. 7B. Fastener 702 results from using a punch tool with punch point 602 to form the recess pattern in the head of the fastener as well as ramps extending upward from the fastener head surface. Note that fastener 702 is not yet fully completed, as the ramps have not yet been pressed downward into the recess to form the overhang structures as shown in FIGS. 8A-8C.

Many features of fastener 702 are similar to those discussed above for fastener 202. Accordingly, fastener 702 includes a shank 704 with a tip at one end and a head 706 at the opposite end where head 706 includes a recess pattern 708 formed from one or more wing recesses 710. The wing recess pattern 708 matches the wing pattern of punch point 602 used to form fastener head 706.

According to some embodiments, at least one of wing recesses 710 includes ramp structures 712a and 712b on each side directly adjacent to the wing recess 710. Ramp structures 712a and 712b may be formed on the fastener head 706 due to material being pushed into the one or more corresponding pockets 606a and 606b of punch point 602 during the formation of the fastener head. Accordingly, ramp structure 712a is molded to match the geometry of pocket 606a and ramp structure 712b is molded to match the geometry of pocket 606b. In some examples, each sidewall of the wing recess 710 is aligned with (e.g., is co-planar with) an inward-facing sidewall of the corresponding ramp structure 712a and 712b such that there is a seamless transition between the sidewalls. In some embodiments, each wing recess 710 has corresponding ramp structures 712a and 712b adjacent to it.

According to some embodiments, one or more of wing recesses 710 includes an elongated rib or protrusion 714 along one of its sidewalls. Protrusion 714 may extend along an entire height, or at least 50% of an entire height, of wing recess 710. Protrusion 714 may be created by notch 608 on punch point 602. Briefly, as punch point 602 is driven into a material blank to form recess pattern 708, notch 608 creates a corresponding cast of its concave (or other indented geometry) shape within wing recess 710. According to some embodiments, protrusion 714 is arranged on a sidewall of wing recesses 710 that engages with a bit tip during a loosening operation of fastener 702. In some examples, each wing recess 710 includes a corresponding protrusion 714 on one of its sidewalls.

FIGS. 8A-8C illustrate several cross-sectional and perspective views of the example fastener of FIGS. 7A-7C after a next (e.g., second) stage of its formation, according to some embodiments. FIG. 8C provides a cross-section view taken across the plane A-A from FIG. 8B. Fastener 702 shown in FIGS. 8A-8C results from using another punch tool to flatten down ramp structures 712a and 712b and form corresponding overhang structures 802a and 802b, similarly to that described above for fastener 202 in FIGS. 3A-3C. Accordingly, overhang structures 802a and 802b extend laterally outward at a top of a given wing recess 710. In some examples, a top surface of overhang structure 802a and 802b may be aligned with (e.g., co-planar with) a top surface of the head 706 of the fastener. Each of overhang structures 802a and 802b may extend, for example, lengthwise along at least 30% or at least 50% or at least 75% of the total length of the corresponding wing recess 710 adjacent to it. In some such examples, overhang structures 802a and 802b extend lengthwise by between about 0.050″ and about 0.070″, such as around 0.061″. As noted above, one overhang structure 802a may extend laterally further away from its corresponding sidewall compared to the other overhang structure 802b. This may provide greater engagement with overhang structure 802a with a bit tip during a tightening operation. In some embodiments, each of the wing recesses 710 of fastener 702 has corresponding overhang structures 802a and 802b adjacent to it.

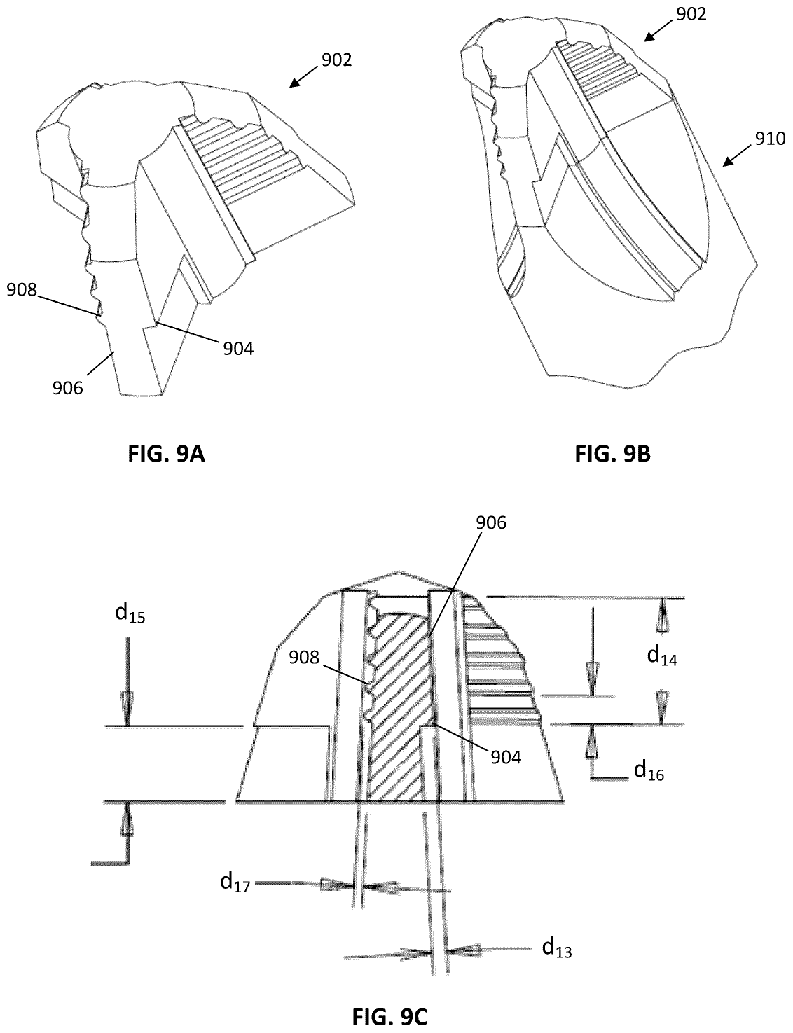

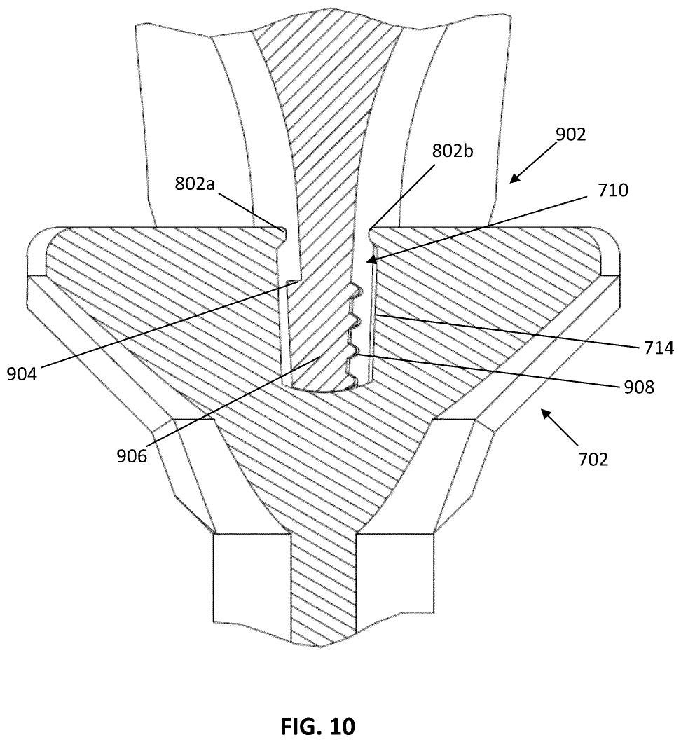

FIG. 9A illustrates a perspective view of a driver bit tip 902 for engagement with the strip-resistant fastener 702 of FIG. 8A, according to some embodiments. FIG. 9B illustrates a perspective view of driver bit tip 902 at the end of a shank 910, which may include an elongated body that continues to extend away from driver bit tip 902 to a distal end configured to engage with a driver tool (e.g., rotary tool, screwdriver, etc.). FIG. 4C illustrates a side view of driver bit tip 902.

Driver bit tip 902 includes step features 904 that are designed to engage with the corresponding overhang structure 802a of fastener 702 to “lock” the bit in place and reduce or eliminate cam-out when driving fastener 702 into a workpiece. According to some embodiments, driver bit tip 902 includes one or more wings 906 that have a similar design to punch point 602 used to form the fastener design. Accordingly, driver bit tip 902 includes one or more wings 906 arranged in a given pattern that matches the wing recess pattern 708 found on fastener head 706. In the illustrated example, driver bit tip 902 includes three wings in a tri-cross pattern. Other patterns may be used, as described above.

According to some embodiments, and similar to bit tip 402 described above, at least one of the wings 906 includes a stepped design with two sections having different widths. A first section of wing 906 may have a first width and a second section of the wing may have a second width that is greater than the first width. The difference in widths between the sections creates a step discontinuity along a sidewall of wing 906 at the boundary between the two sections. The first sidewall section may be located between the second sidewall section and shank 910.

As seen in FIG. 9C, the difference in width between the first sidewall section and second sidewall section may have a value d₁₃ between about 0.08″ and about 0.12″, according to some examples. In some embodiments, a total height of the second sidewall section is at least 1.5× or at least 2.0× a total height of the first sidewall section. In an example, a total height of the second sidewall section d₁₄ is between about 0.086″ and about 0.091″ and the total height of the first sidewall section d₁₅ is between about 0.050″ and about 0.060″.

According to some embodiments, one or more wings 906 includes a series of rib structures 908 along one of its sidewalls. Rib structures 908 may be located on the opposite sidewall from step feature 904 of a given wing 906. Rib structures 908 may include any number of protruding lines or shapes that extend away from the otherwise flat sidewall surface of wing 906. According to some embodiments, rib structures 908 may be separated from one another along the height of a given wing 906 by a distance d₁₆ between about 0.018″ and about 0.022″. Rib structures 908 may extend away from the sidewall surface of wing 906 by a distance d₁₇ between about 0.004″ and about 0.007″, in some examples. In some embodiments, each wing 906 of bit tip 902 includes a step feature 904 on one sidewall and one or more rib structures 908 on the opposite sidewall.

FIG. 10 illustrates a driver bit tip 902 having been inserted into a strip-resistant fastener 702, according to some embodiments. Once the driver bit tip wings 906 have been inserted into the corresponding wing recesses 710 of the fastener head, driver bit tip 902 may be twisted clockwise (e.g., tightening) to engage step 904 below a corresponding overhang structure 802a or may be twisted counterclockwise (e.g., loosening) to engage rib structures 908 against protrusion 714. At this point, driver bit tip 902 is “cammed-in” or otherwise locked in place and will not cam-out when tightening or loosening the fastener. As noted above, driver bit tip 902 may be on the end of a shank that extends away from driver bit tip 902 for easier coupling to, for example, a rotary tool or a screwdriver. Note that overhang structure 802b can be arranged on the same sidewall that includes protrusion 714 to provide further protection against camming-out during a loosening operation. The friction forces on the contact points between rib structures 908 and protrusion 714 maintain driver bit tip 902 in place within wing recesses 710 when rib structures 908 are pushed against protrusion 714. In some embodiments, instead of rib structures 908, wing 906 can include step 904 on both sides of wing 906 to engage directly with overhang structure 802a during a tightening operation and with overhang structure 802b during a loosening operation.

Manufacturing Methodology

FIGS. 11A-11F illustrate a cold-forming fabrication process for making a fastener according to some embodiments of the present disclosure. For example, the illustrated fabrication process may be used to form either fastener 202 or fastener 702. In FIG. 11A, a material blank 1102 is aligned over a die 1104 having a mold to shape the elongated portion and the head of the fastener. Blank 1102 may be a slug of whatever material the fastener is to be, such as different types of steel. Die 1104 includes an opening having a mold shape to form the fastener after the material blank 1102 has been forced into it. In some examples, die 1104 includes a pin 1106 that plugs one end of the opening and can be used to eject the fastener from die 1104 after it has been formed. A first blow assembly 1108 is aligned over blank 1102 (or blank 1102 is aligned over first blow assembly 1108) in a cold-forming machine. First blow assembly 1108 may have a first blow punch 1110 which provides a surface designed to impact blank 1102 and push it into die 1104.

In FIG. 11B, first blow assembly 1108 is pushed forward and punches blank 1102 into die 1104. This action leaves a blob 1112 of exposed material sticking out from die 1104 while the remaining material is forced into the die mold and up against pin 1106, which forms the shank of the fastener and at least part of the head of the fastener.

In FIG. 11C, a second blow assembly 1114 is brought into alignment over the blank material that has been wedged into the die (or the blank is aligned over the second blow assembly). Second blow assembly 1114 includes a punch point 1116, such as punch point 104 from FIGS. 1A-1D or punch point 602 from FIGS. 6A-6C. In one example, punch point 1116 includes a raised tri-cross wing pattern to form the corresponding wing recess pattern in the fastener head, and one or more pockets adjacent to corresponding wings to form ramp structures in the fastener head.

In FIG. 11D, second blow assembly 1114 is pushed forward and stamps the exposed material blob 1112 into the desired shape for the head of the fastener, which includes forming the wing recess pattern (e.g., one or more wing recesses) in the head of the fastener and forming one or more ramp structures. Depending on the desired design, one or more protrusions may also be formed along the sidewalls of any of the one or more wing recesses in the fastener head.

In FIG. 11E, a third blow assembly 1118 is brought into alignment over the formed fastener head 1120 still wedged within die 1104 (or the formed fastener is brought into alignment with the third blow assembly). In some embodiments, the formed fastener is removed from the die and placed into a second die that is aligned with third blow assembly 1118. According to some embodiments, third blow assembly 1118 has a flat front-facing surface 1122 designed to stamp down on the fastener head 1120 and push down the one or more ramp structures 1124 that are raised off of fastener head 1120. According to some embodiments, third blow assembly 1118 includes one or more protruding wing structures that may match the wing recess pattern (or at least a portion of it) on fastener head 1120.

In FIG. 11F, third blow assembly 1118 is pushed forward such that the flat front-facing surface 1122 (or at least a flat portion of the surface) pushes down on the one or more ramp structures 1124 and bends or mashes them inwards towards their corresponding wing recesses. Each ramp structure is pushed down to form a corresponding overhang structure 1126 adjacent to a wing recess. Each resulting overhang structure thus extends laterally inward from the recess sidewall toward a central axis running through the shank and head of the fastener, in a similar fashion to overhang structures 302 (FIGS. 3A-3C) or overhang structures 802a-b (FIGS. 8A-8C). In examples where third blow assembly 1118 includes one or more protruding wing structures, the wing structures may be aligned over the wing recess pattern such that they enter into the wing recess pattern during the stamping process and prevent the one or more ramp structures 1124 from extending too far laterally as they are pushed down by third blow assembly 1118 to form overhang structures 1126.

### Further Example Embodiments

The following examples pertain to further embodiments, from which numerous permutations and configurations will be apparent.

Example 1 is a fastener that includes a shank and a head at one end of the shank. The head comprises a recess pattern that includes one or more wing recesses with sidewalls that extend from the head towards the shank. The head also includes an overhang structure at a top end of at least one of the sidewalls. The overhang structure extends laterally outward from the sidewall.

Example 2 includes the fastener of Example 1, wherein the recess pattern is a tri-cross pattern or cruciform pattern.

Example 3 includes the fastener of Example 1, wherein the recess pattern is a flat pattern with two wing recesses.

Example 4 includes the fastener of any one of Examples 1-3, wherein at least one sidewall of each of the one or more wing recesses includes the overhang structure.

Example 5 includes the fastener of any one of Examples 1-4, wherein the at least one of the sidewalls is a sidewall of a corresponding wing recess, the corresponding wing recess having a length that extends radially outward from a central axis passing axially through the center of the head and the shank, and the overhang structure extends lengthwise along at least 50% of the length of the corresponding wing recess.

Example 6 includes the fastener of any one of Examples 1-5, wherein the head has a top surface and the overhang structure is monolithically integrated with the top surface of the head. In some examples, an angle is formed by a bottom surface of the overhang structure and the sidewall from which it extends. The angle may vary from one example to the next and may be, for instance, an oblique angle, a right angle, or an acute angle. The bottom surface of the overhang structure may be rounded or curvilinear or otherwise non-straight. The sidewall may be straight or tapered inward or tapered outward (reverse-taper).

Example 7 includes the fastener of any one of Examples 1-6, wherein the shank includes one or more threads along at least a portion of a length of the shank.

Example 8 includes the fastener of any one of Examples 1-7, wherein the overhang structure is a first overhang structure and the one or more wing recesses includes a second overhang structure at a top end of a sidewall opposite from the first overhang structure.

Example 9 includes the fastener of Example 8, wherein each of the one or more wing recesses includes the corresponding first overhang structure and second overhang structure.

Example 10 includes the fastener of any one of Examples 1-9, wherein at least one of the sidewalls of a given wing recess of the one or more wing recesses includes an elongated protrusion that runs along at least 50% of an entire height of the given wing recess.

Example 11 is a bit that includes a shank having a tip at one end of the shank. The tip comprises one or more wings extending away from the shank. At least one of the one or more wings includes a first section having a first width and a second section having a second width greater than the first width. The first section is between the shank and the second section. The bit is part of, or attachable to, a screwdriver or rotary tool.

Example 12 includes the bit of Example 11, wherein a sidewall of the at least one of the one or more wings has a step discontinuity between the first section and the second section.

Example 13 includes the bit of Example 12, wherein the second section having the second width extends an entire distance between the step discontinuity and a top end of the at least one of the one or more wings.

Example 14 includes the bit of Example 12 or 13, wherein the sidewall is a first sidewall and the at least one of the one or more wings has a second sidewall opposite from the first sidewall that includes one or more rib features protruding from the second sidewall.

Example 15 includes the bit of Example 14, wherein the one or more rib features includes a plurality of parallel protrusions having a longest length dimension that is substantially orthogonal to a height of the at least one of the one or more wings.

Example 16 includes the bit of any one of Examples 11-15, wherein each of the one or more wings includes a corresponding first section having a first width and a corresponding second section having a second width greater than the first width, the corresponding first section being between the shank and the corresponding second section.

Example 17 includes the bit of any one of Examples 11-16, wherein the one or more wings includes three wings arranged in a tri-cross pattern.

Example 18 includes the bit of any one of Examples 11-16, wherein the one or more wings includes two wings arranged in a flat pattern.

Example 19 includes the bit of any one of Examples 11-18, wherein the second width is between about 0.08″ and about 0.12″ greater than the first width.

Example 20 includes the bit of any one of Examples 11-19, wherein the second section has a height that is at least 2× greater than a height of the first section.

Example 21 is a punch tool for forming a head shape of a fastener, the punch tool includes a body having a surface at an end of the body and a punch point at the end of the body. The punch point includes one or more wings extending away from the surface and arranged in a pattern that matches a recess pattern on a head of the fastener, and at least one pocket extending below the surface and directly adjacent to a corresponding wing of the one or more wings.

Example 22 includes the punch tool of Example 21, wherein the punch tool is configured for use within a cold-forming machine.

Example 23 includes the punch tool of Example 21 or 22, wherein the one or more wings includes three wings arranged in a tri-cross pattern.

Example 24 includes the punch tool of Example 21 or 22, wherein the one or more wings includes two wings arranged in a flat pattern.

Example 25 includes the punch tool of any one of Examples 21-24, wherein each of the one or more wings includes a corresponding at least one pocket adjacent to it.

Example 26 includes the punch tool of any one of Examples 21-25, wherein the at least one pocket has a greatest depth directly adjacent to the corresponding wing, and the depth of the at least one pocket decreases in a direction moving away from the corresponding wing.

Example 27 includes the punch tool of Example 26, wherein the greatest depth of the at least one pocket is between about 0.014″ and about 0.022″.

Example 28 includes the punch tool of any one of Examples 21-27, wherein the corresponding wing has a length that extends radially outward from a central axis passing axially through the center of the punch point, and the at least one pocket extends lengthwise along at least 50% of the length of the corresponding wing.

Example 29 includes the punch tool of any one of Examples 21-28, wherein the punch point comprises a first pocket adjacent to one side of the corresponding wing and a second pocket adjacent to an opposite side of the corresponding wing.

Example 30 includes the punch tool of Example 29, wherein the first pocket has a greatest depth directly adjacent to the corresponding wing that is higher than a greatest depth of the second pocket directly adjacent to the corresponding wing.

Example 31 is a method of forming a fastener. The method includes aligning a material blank over a die shaped to form a part of the fastener; punching the material blank into the die using a first blow assembly; punching the material blank with a second blow assembly to form a recess pattern in a head of the fastener and one or more ramp structures arranged around the recess pattern; punching the head of the fastener with a third blow assembly having a flat front surface, thereby bending or mashing the ramp structures into the top portion of the recess pattern.

The foregoing description of example embodiments of the disclosure has been presented for the purposes of illustration and description. It is not intended to be exhaustive or to limit the disclosure to the precise forms disclosed. Many modifications and variations are possible in light of this disclosure. It is intended that the scope of the disclosure be limited not by this detailed description, but rather by the claims appended hereto.

What is claimed is:

1. A fastener comprising:
a shank; and
a head on one end of the shank, wherein the head comprises a recess pattern that includes one or more wing recesses with sidewalls that extend from the head towards the shank, and an overhang structure at a top end of at least one of the sidewalls, the overhang structure extending laterally outward from the sidewall.

2. The fastener of claim 1, wherein the recess pattern is a tri-cross pattern, a cruciform pattern, or a flat pattern.

3. The fastener of claim 1, wherein at least one sidewall of each of the one or more wing recesses includes the overhang structure.

4. The fastener of claim 1, wherein the at least one of the sidewalls is a sidewall of a corresponding wing recess, the corresponding wing recess having a length that extends radially outward from a central axis passing axially through the center of the head and the shank, and the overhang structure extends lengthwise along at least 50% of the length of the corresponding wing recess.

5. The fastener of claim 1, wherein the head has a top surface and the overhang structure is monolithically integrated with the top surface of the head.

6. The fastener of claim 1, wherein the overhang structure is a first overhang structure and the one or more wing recesses includes a second overhang structure at a top end of a sidewall opposite from the first overhang structure.

7. The fastener of claim 1, wherein at least one of the sidewalls of a given wing recess of the one or more wing recesses includes an elongated protrusion that runs along at least 50% of an entire height of the given wing recess.

8. A bit comprising:
a shank having a tip at one end of the shank, wherein the tip comprises one or more wings extending away from the shank,
wherein at least one of the one or more wings includes a first section having a first width and a second section having a second width greater than the first width, the first section being between the shank and the second section,
wherein the bit is part of, or attachable to, a screwdriver or rotary tool.

9. The bit of claim 8, wherein a sidewall of the at least one of the one or more wings has a step discontinuity between the first section and the second section.

10. The bit of claim 9, wherein the second section having the second width extends an entire distance between the step discontinuity and a top end of the at least one of the one or more wings.

11. The bit of claim 9, wherein the sidewall is a first sidewall and the at least one of the one or more wings has a second sidewall opposite from the first sidewall that includes one or more rib features protruding from the second sidewall.

12. The bit of claim 11, wherein the one or more rib features includes a plurality of parallel protrusions having a longest length dimension that is substantially orthogonal to a height of the at least one of the one or more wings.

13. The bit of claim 8, wherein the second section has a height that is at least 2× greater than a height of the first section.

14. A punch tool for forming a head shape of a fastener, the punch tool comprising:
a body having a surface at an end of the body; and
a punch point at the end of the body, the punch point comprising
one or more wings extending away from the surface and arranged in a pattern that matches a recess pattern on a head of the fastener, and
at least one pocket extending below the surface and directly adjacent to a corresponding wing of the one or more wings.

15. The punch tool of claim 14, wherein the punch tool is configured for use within a cold-forming machine.

16. The punch tool of claim 14, wherein each of the one or more wings includes a corresponding at least one pocket adjacent to it.

17. The punch tool of claim 14, wherein the at least one pocket has a greatest depth directly adjacent to the corresponding wing, and the depth of the at least one pocket decreases in a direction moving away from the corresponding wing.

18. The punch tool of claim 14, wherein the corresponding wing has a length that extends radially outward from a central axis passing axially through the center of the punch point, and the at least one pocket extends lengthwise along at least 50% of the length of the corresponding wing.

19. The punch tool of claim 14, wherein the punch point comprises a first pocket adjacent to one side of the corresponding wing and a second pocket adjacent to an opposite side of the corresponding wing.

20. The punch tool of claim 19, wherein the first pocket has a greatest depth directly adjacent to the corresponding wing that is higher than a greatest depth of the second pocket directly adjacent to the corresponding wing.
